(19) United States
(12) Patent Application Publication
(10) Pub. No.: US 2014/0278963 A1
(43) Pub. Date: Sep. 18, 2014

(54) Automated System for Marketing to Gas Station Customers

(71) Applicant: NATIONAL PAYMENT CARD ASSOCIATION, Coconut Creek, FL (US)

(72) Inventor: Joseph R. Randazza, Coconut Creek, FL (US)

(73) Assignee: National Payment Card Association, Coconut Creek, FL (US)

(21) Appl. No.: 13/833,358

(22) Filed: Mar. 15, 2013

(51) Int. Cl. G06Q 30/02

(52) U.S. Cl. CPC G06Q 30/0253
USPC 705/14.51

(57) ABSTRACT

Geomapping-based marketing, to gas station customers.

### BACKGROUND OF THE INVENTION

Certain technologies exist for marketing and advertising to consumers. However, to be able to reach more consumers, more effectively, and/or at less cost would be advantageous to merchants.

### SUMMARY OF THE INVENTION

In a preferred embodiment, the invention provides an automated marketing method comprising: receiving an incoming machine-readable data set; in real-time upon receiving the data set, processing the incoming data set for whether the data set has originated from a gas pump transaction; if the processing step produces a determination that the data set has originated from a gas pump transaction, then, in real-time, locating an address of an electronic device of a customer associated with the data set; and sending a communication to the electronic device of the customer associated with the data set; wherein the receiving, processing, address-locating, and sending steps are performed by a computer, processor, or other machine; such as inventive methods in which the data-receiving step comprises receiving an incoming machine-readable data set that has originated from a card being swiped by a customer at a gas pump; inventive methods in which the data-processing step comprises parsing the received data set for presence of a predefined that represents that the data set has originated at a gas pump; inventive methods in which the communication-sending step is performed not more than a few seconds after the customer has originated the gas pump transaction; inventive methods in which the communication-sending step comprises sending a communication (such as, e.g., a coupon, a text message, etc.) to the electronic device of the customer associated with the data set, not more than a few seconds after the customer has interacted with a system at the gas pump from where the data set originated; inventive methods wherein the receiving and processing steps are performed by a computer system that receives data sets that originate from gas pump transactions and data sets that originate from elsewhere than gas pump transactions; inventive methods wherein the processing step comprises parsing a “merchant type” field within the received data set; inventive methods wherein in the processing step, a received data set that originated from a pump-purchase is identified as a gas pump transaction and triggers communication-sending, but a received data that originated from an inside-sale at a gas station is not identified as a gas pump transaction and does not trigger communication-sending; and other inventive methods.

The invention in another preferred embodiment provides an automated method of sorting incoming payment transactions for further processing, comprising: receiving a plurality of incoming payment transactions wherein each payment transaction is in a form of a machine-readable data set, wherein the receiving step is performed by a computerized payment system; within seconds of a customer having initiated a payment transaction at a retail site, parsing a received data set for the payment transaction, for presence of a certain predefined data segment that indicates that the payment transaction was initiated at a gas pump; such as, e.g., inventive methods wherein the parsing comprises searching a “merchant type” field; and other inventive methods.

In another preferred embodiment the invention provides a method of marketing to an individual during a time window of about 2 to 4 minutes when the individual is captive during a refueling operation at a fuel pump at a gas station, comprising: after the individual has initiated a transaction at the fuel pump to purchase fuel from the fuel pump at the gas station, sending an electronic communication to an electronic device associated with the individual, in real-time of when the individual initiated the transaction at the fuel pump, wherein the electronic communication comprises content relating to a store at the gas station, wherein the sending is performed by a computer; such as, e.g., inventive methods wherein the sending step comprises sending content that comprises an offer to make an in-store purchase at the store; inventive methods that comprise marketing to the individual after the individual has initiated the transaction at the fuel pump and while the individual is on-site at the gas station; and other inventive methods.

### DETAILED DESCRIPTION OF A PREFERRED EMBODIMENT OF THE INVENTION

The present invention is particularly directed to data-processing performed by a computer or computer system during a plurality of respective few-minute windows of time (such as a plurality of few-minute windows of time when a customer is engaged in buying and pumping gas). An example of a computer or computer system useable in the present invention is a computer or computer system that simultaneously receives and processes a large number of distinct machine-readable data sets from many different customers scattered over various retail locations, such as various retail locations across the United States.

Examples of retail locations are gas stations, grocery stores, etc.

Most gas stations are equipped for customers to initiate a transaction outside at the pump, or inside at the register. When a customer initiates a transaction outside at the pump, a machine-readable set of data is created which is sent into a computerized payment system (such as, e.g., a computerized payment system operated by National Payment Card Association; a computerized payment system accessed when a customer swipes a VISA card; a computerized payment system accessed when a customer swipes a Master Card; etc.).

An example of a computer system used in practicing the invention is a computer system that performs the receiving 100 and processing 110 steps and that receives data sets that originate from gas pump transactions and also receives data sets that originate from elsewhere than gas pump transactions.

Referring to FIG. 1, and according to the invention, a computerized payment system performs a step of receiving 100 an incoming data set which is machine readable.

An example of a data-receiving step 100 useable in a method according to an embodiment of the invention (such as, e.g., an inventive automated marketing method, an inventive automated method of sorting incoming payment transactions for further processing, an inventive automated method of marketing to an individual during a time window of about 2 to 4 minutes when the individual is captive during a refueling operation at a fuel pump at a gas station) is, e.g., a data-receiving step that comprises receiving an incoming machine-readable data set that has originated from a card being swiped by a customer at a gas pump; a data-receiving step that comprises receiving an incoming machine-readable data set that has originated from a signal or signals received from a mobile device used by a customer in initiating a gas pump transaction; etc.

An example of a data-processing step 110 useable in the invention is, e.g., a processing step that comprises parsing the received data set for presence of a predefined that represents that the data set has originated at a gas pump; a processing step that comprises parsing a “merchant type” field within the received data set; a processing step in which a received data set that originated from a pump-purchase is identified as a gas pump transaction and triggers communication-sending 120, but a received data that originated from an inside-sale at a gas station is not identified as a gas pump transaction and does not trigger communication-sending; etc.

It is essential that the data-processing step 110 be performed in real-time, because a customer who initiates a payment transaction outdoors at the gas pump will only be captive for a very short period of time, such as about 2-4 minutes, before his vehicle is fueled-up and he is ready to depart.

A preferred example of data-processing 110 is parsing data that has been received from a device at a gas pump that has interacted with a customer's card, customer's mobile device, or customer's other payment token, wherein the device at the gas pump sent the data received from the customer into the computerized payment system along with a predefined Merchant Type code in a particular field in the sent data packet. For example, a computerized payment service might issue a predefined Merchant Type code of “01” for at-the-pump, “02” for gas-station at the counter, “03” for other retail, and parse incoming data sets for whether the Merchant Type field has the “01” code.

Preferably, the data-processing step 110 and communication-sending step 120 should be performed while meanwhile the incoming data set also being processed to accomplish the core payment transaction.

Examples of a communication-sending step 120 useable in the invention are, e.g., a communication-sending step that is performed not more than a few seconds after the customer has originated the gas pump transaction; a communication-sending step that comprises sending a communication (such as, e.g., a coupon, a text message, etc.) to the electronic device of the customer associated with the data set, not more than a few seconds after the customer has interacted with a system at the gas pump from where the data set originated.

Preferably an automated payment system that issues cards for a customer to use, during an enrollment step intakes from a customer information that includes the customer's cell phone number and/or email of his mobile device, so that when the customer's card is swiped at a gas pump, and the computerized system receives 100 and processes 110 that data set, the computerized payment system has a stored address record for the customer that the computerized payment system uses as the address for the communication sent in the sending 120 step.

The invention may further be appreciated with reference to the following examples, without the invention being limited to the examples.

### Example 1

### Automated Marketing Method

A computer, processor, or other machine within an automated system receives an incoming machine-readable data set, followed by, in real-time upon receiving the data set, processing the incoming data set for whether the data set has originated from a gas pump transaction. If the processing step produces a determination that the data set has originated from a gas pump transaction, then, in real-time, a computer, processor or other machine within the automated system locates an address of an electronic device of a customer associated with the data set, followed by a computer, processor or other machine within the automated system sending a communication to the electronic device of the customer associated with the data set.

### Example 2

### Automated Method of Sorting Incoming Payment Transactions for further Processing

A computer, processor, or other machine within an automated system receives a plurality of incoming payment transactions wherein each payment transaction is in a form of a machine-readable data set, wherein the receiving step is performed by a computerized payment system. Within seconds of a customer having initiated a payment transaction at a retail site, a step is performed, by a computer, processor or other machine within the automated system, of parsing (such as, e.g., parsing that comprises searching a “merchant type” field) a received data set for the payment transaction, for presence of a certain predefined data segment that indicates that the payment transaction was initiated at a gas pump.

### Example 3

### Automated Method of Marketing to an Individual During a Time Window of about 2 to 4 Minutes when the Individual is Captive During a Refueling Operation at a Fuel Pump at a Gas Station

After the individual has initiated a transaction at the fuel pump to purchase fuel from the fuel pump at the gas station, an electronic communication is sent, in a sending step (such as, e.g., a sending step that comprises sending content that comprises an offer to make an in-store purchase at the store), to an electronic device associated with the individual, in real-time of when the individual initiated the transaction at the fuel pump, wherein the electronic communication comprises content relating to a store at the gas station. The sending step is performed by a computer, processor or other machine.

### Example 4

In this example, a customer has enrolled herself with a company operating a computerized payment system and she has received a card to use to swipe to initiate payment transactions. During the enrollment process, she provided her cell phone number and/or she indicated that she had a mobile device and provided its email address.

When she swipes her card at a grocery store, the computerized payment system parses the received data set from the grocery store and determines that the Merchant Type is not that of an at-the-pump code, and sends her no communication.

When she swipes her card inside at the counter at a gas station, the computerized payment system parses the received data set from the gas station and determines that the Merchant Type is not that of an at-the-pump code, and sends her no communication.

When she swipes her card outside at a gas pump, the computerized payment system parses the received data set from the gas pump device and determines that the Merchant Type is that of an at-the-pump code. Then, the automated system, in real time, sends her a communication that is stored in a database of communications to be sent and that is particular to the gas station convenience store on whose premises she is present, which the automated system ascertains based on the Merchant Identification Number also in the received data set.

### Example 4A

An example of a computerized payment system useable for Example 4 is a system that comprises:

a processor that performs a series of enrollment steps, whereby data from a plurality of customers is received;

a database wherein customer data received during the enrollment steps is stored, wherein for each customer a record is stored including a card number issued to the customer, and a mobile device email address or cell phone associated with the customer;

a processor that performs a step of parsing a data set received from a retail site for whether the received data set includes a Merchant Type code that was predefined as being an at-the-pump Merchant Type;

a memory in which is stored a set of sendable communications, each sendable communication being associated with a particular gas station having a convenience store;

a processor that performs a step of determining, based on the received data set, at what gas station the customer is present;

a real-time sending module that performs a step of sending, to the customer at the mobile device email address or cell phone in the enrollment record for the customer, a stored communication that is linked to the gas station where the customer is present, within seconds the data set having been received from the retail site.

### Example 4B

For use in Examples 4-4A, a device is provided at a gas pump. The device interacts with the customer, such as by receiving a swiped card, interacting with a cell phone of the customer, etc. The at-the-pump device in operation combines the data received from the customer with at least a predefined Merchant Type code, and a predefined Merchant ID, to construct a data set (data packet) that is sent to an automated payment system (preferably an automated payment system that is remote from the gas station).

When the automated payment system receives such a data set, the automated payment system parses the data set, identifies (by reading the Merchant Type code in the data packet) that a customer is currently present at a gas pump, identifies at what gas station the customer is currently present (by reading the Merchant ID in the data packet), retrieves a to-be-sent communication (such as an in-store coupon, an in-store offer, etc.) linked to that Merchant ID, identifies the customer (by reading the customer card number in the data packet), retrieves the cell phone number or mobile device email stored in the enrollment database for the customer, and sends to the customer's mobile device the store-specific communication.

While the invention has been described in terms of a preferred embodiment, those skilled in the art will recognize that the invention can be practiced with modification within the spirit and scope of the appended claims.

What I claim as my invention is:

1. An automated marketing method comprising:
receiving an incoming machine-readable data set;
in real-time upon receiving the data set, processing the incoming data set for whether the data set has originated from a gas pump transaction;
if the processing step produces a determination that the data set has originated from a gas pump transaction, then, in real-time,
locating an address of an electronic device of a customer associated with the data set; and
sending a communication to the electronic device of the customer associated with the data set,
wherein the receiving, processing, address-locating, and sending steps are performed by a computer, processor, or other machine.

2. The method of claim 1, wherein the communication-sending step is performed not more than a few seconds after the customer has originated the gas pump transaction.

3. The method of claim 1, wherein the processing step comprises parsing the received data set for presence of a predefined that represents that the data set has originated at a gas pump.

4. The method of claim 1, wherein the receiving step comprises receiving an incoming machine-readable data set that has originated from a card being swiped by a customer at a gas pump.

5. The method of claim 1, wherein the communication-sending step comprises sending a communication selected from the group consisting of:
a coupon;
a text message;
to the electronic device of the customer associated with the data set, not more than a few seconds after the customer has interacted with a system at the gas pump from where the data set originated.

6. The method of claim 1, wherein the receiving and processing steps are performed by a computer system that receives data sets that originate from gas pump transactions and data sets that originate from elsewhere than gas pump transactions.

7. The method of claim 1, wherein the processing step comprises parsing a “merchant type” field within the received data set.

8. The method of claim 1, wherein in the processing step, a received data set that originated from a pump-purchase is identified as a gas pump transaction and triggers communication-sending, but a received data that originated from an inside-sale at a gas station is not identified as a gas pump transaction and does not trigger communication-sending.

9. An automated method of sorting incoming payment transactions for further processing, comprising:
receiving a plurality of incoming payment transactions wherein each payment transaction is in a form of a machine-readable data set, wherein the receiving step is performed by a computerized payment system;
within seconds of a customer having initiated a payment transaction at a retail site, parsing a received data set for the payment transaction, for presence of a certain predefined data segment that indicates that the payment transaction was initiated at a gas pump.

10. The method of claim 9, wherein the parsing comprises searching a “merchant type” field.

11. A method of marketing to an individual during a time window of about 2 to 4 minutes when the individual is captive during a refueling operation at a fuel pump at a gas station, comprising:
after the individual has initiated a transaction at the fuel pump to purchase fuel from the fuel pump at the gas station, sending an electronic communication to an electronic device associated with the individual, in real-time of when the individual initiated the transaction at the fuel pump, wherein the electronic communication comprises content relating to a store at the gas station, wherein the sending is performed by a computer.

12. The method of claim 11, wherein the sending step comprises sending content that comprises an offer to make an in-store purchase at the store.

13. The method of claim 11, comprising marketing to the individual after the individual has initiated the transaction at the fuel pump and while the individual is on-site at the gas station.

14. A computerized payment system, comprising:
a processor that performs a series of enrollment steps, whereby data from a plurality of customers is received;
a database wherein customer data received during the enrollment steps is stored, wherein for each customer a record is stored including a card number issued to the customer, and a mobile device email address or cell phone associated with the customer;
a processor that performs a step of parsing a data set received from a retail site for whether the received data set includes a Merchant Type code that was predefined as being an at-the-pump Merchant Type;
a memory in which is stored a set of sendable communications, each sendable communication being associated with a particular gas station having a convenience store;
a processor that performs a step of determining, based on the received data set, at what gas station the customer is present;
a real-time sending module that performs a step of sending, to the customer at the mobile device email address or cell phone in the enrollment record for the customer, a stored communication that is linked to the gas station where the customer is present, within seconds the data set having been received from the retail site.
